(19) United States
(12) Patent Application Publication
(10) Pub. No.: US 2024/0104166 A1
(43) Pub. Date: Mar. 28, 2024

(54) SOFTMAX FUNCTION APPROXIMATION CALCULATION DEVICE, APPROXIMATION CALCULATION METHOD, AND APPROXIMATION CALCULATION PROGRAM

(71) Applicant: Konica Minolta, Inc., Tokyo (JP)

(72) Inventors: RYUSUKE YAMANO, Asahi-ku, Osaka-shi, Osaka (JP); HIROSHI UCHINO, Koganei-shi, Tokyo (JP)

(21) Appl. No.: 18/275,160

(22) PCT Filed: Jan. 19, 2022
(86) PCT No.: PCT/JP2022/001735

§ 371 Date: Jul. 31, 2023

(30) Foreign Application Priority Data
Feb. 5, 2021 (JP) 2021-017535

(51) Int. Cl. G06F 17/17; G06F 7/499

(52) U.S. Cl. CPC G06F 17/17; G06F 7/49947

(57) ABSTRACT

A maximum value of an input value obtained by a comparison circuit 403 is subtracted from each input value by a subtraction circuit 404, an approximate value of an exponential function value corresponding to divided values a₁, a₂, and a₃ obtained by slicing the obtained difference value a for each bit range is read from look up tables table1, table2, and table3 by a look up table reference circuit 406, and is multiplied by a multiplication circuit 408 to calculate an approximate value of the exponential function value having the difference value a as an exponent. At the time of multiplication, a fraction is rounded off, and the number of bits is equalized by a right shift operation. Using a total value of the approximate values obtained by a summing circuit 409, each approximate value is divided by the divider circuit 410 to obtain an approximate value of the softmax function value. In this way, a look up table size used for approximation calculation of the exponential function value of the softmax function can be suppressed without extremely deviating a sign of an error using a fixed-point number or an integer as the input value.

### TECHNICAL FIELD

The present disclosure relates to a softmax function approximation calculation device, an approximation calculation method, and an approximation calculation program, and particularly relates to a technique for speeding up numerical calculation of a softmax function in a neural network using a deep learning algorithm.

### BACKGROUND ART

In recent years, deep learning algorithms have been remarkably developed, and their applications have been expanded to various technical fields. Deep learning is a machine learning method using a multilayer neural network, and there are several types of layers constituting the neural network. One of the several types of layers is a softmax layer. The softmax layer is frequently used in a neural network applied to the field of natural language processing, and the softmax layer also becomes frequently used in neural networks applied to the field of image processing in which the use frequency of the softmax layer is originally low.

In the neural networks applied to the field of image processing, a large number of convolution layers leads to a long processing time related to the convolution layers, and a large number of connection of fully-connected layers also leads to a long processing time, resulting in a large proportion of the processing time in the entire processing time. On the other hand, the proportion of the processing time of the softmax layer to the entire processing time is small. Therefore, it cannot be said that a measure for speeding up the processing of the softmax layer has been sufficiently studied.

However, since an exponential function is used for the softmax function used in the softmax layer, a processing load required for numerical calculation is high. For such a problem, there has been proposed, for example, a technique of quantizing a floating-point number input to the softmax layer into a fixed-point number or an integer and further performing approximation calculation of an exponential function value using a piecewise linear function (see, for example, Non Patent Literature 1). By using such a technique, the processing load of the softmax layer is reduced, so that the processing time of the softmax layer can be shortened.

### CITATION LIST

### Non Patent Literature

Non Patent Literature 1: Z. Wei, A. Arora, P. Patel and L. John, “Design Space Exploration for Softmax Implementations,” 2020 IEEE 31st International Conference on Application-specific Systems, Architectures and Processors (ASAP), Manchester, United Kingdom, 2020, pp. 45-52, DOI:10.1109/ASAP49362.2020.00017.
Non Patent Literature 2: Hajime TAKAHASHI, Takashi AMISAKI, Shinjiro INABATA, Nobuaki Miyakawa, Shigeru OBARA, Tomoaki MURAKAMI, Kazuhiro KITAMURA, Kazutoshi TANABE, Umpei NAGASHIMA, “Calculation Method of Initial Integral [0] (m) in Molecular Orbital Dedicated Computer MOEngine”

### SUMMARY OF INVENTION

### Technical Problem

The softmax function divides the exponential function value of each input value by the sum of the exponential function values of all input values. As in a graph 1300 illustrated in FIG. 13, since the exponential function is a downward convex function, when the exponential function is approximated using the piecewise linear function as in graphs 1301 to 1307, the sign of an error value is always positive as illustrated in an error 1310. Therefore, since the sum of approximate values of the exponential function values of the respective input values includes the sum of positive error values, the error value tends to be large.

Since the value of the softmax function is calculated using the sum of the exponential function values of all the input values, the large error value included in the sum of the approximate values of the exponential function values of all the input values increases the error in all the values of the softmax function.

In order to reduce such an error value, it is conceivable to use a piecewise linear function obtained by finely dividing a domain of an exponential function. In this way, the deviation (error) between the piecewise linear function and the exponential function in the central portion of each sectional range is reduced. In addition, this error can be made smaller as the classification of the domain of the exponential function is made finer.

However, the case of using the piecewise linear function requires, as illustrated in FIG. 11, a look up table (LUT) for storing information for specifying the piecewise linear function such as a slope and an intercept for each section. When the division of the domain of the exponential function is made finer, the size of the look up table for storing the piecewise linear function increases, and another problem occurs that the storage area is widely occupied. Such a problem is disadvantageous when a neural network is implemented in a device having a limited storage capacity such as an Internet of Things (IoT) device.

The present disclosure has been made in view of the above-described problems, and an object thereof is to provide a softmax function approximation calculation device, an approximation calculation method, and an approximation calculation program capable of suppressing a look up table size used for approximation calculation of an exponential function value without extremely deviating a sign of an error with a fixed-point number or an integer as an input value.

### Solution to Problem

In order to achieve the above object, a softmax function approximation calculation device according to one aspect of the present disclosure is a softmax function approximation calculation device that approximates and calculates, using a plurality of integers or fixed-point numbers as input data, a softmax function value for each piece of the input data, the softmax function approximation calculation device including: a subtraction unit that calculates a difference value between a common numerical value in a plurality of pieces of the input data and the input data; a divided data generation unit that generates divided data by slicing the difference value into a predetermined bit width for each piece of the input data; a storage unit that stores a plurality of look up tables that are provided corresponding to bit positions of the divided data in the input data that is a source of the divided data and store an approximate value of an exponential function value corresponding to the divided data as an integer or a fixed-point number; an acquisition unit that refers to the look up table corresponding to the divided data according to the divided data and acquire the approximate value corresponding to the divided data; a multiplication unit that calculates a multiplication value of the approximate value corresponding to each piece of the divided data between pieces of the divided data generated by slicing one piece of the input data; and an approximation calculation unit that calculates a total value of the multiplication values corresponding to each of the plurality of pieces of the input data and divides the multiplication value by the total value for each piece of the input data to approximate and calculate a softmax function value of the input data.

In this case, there are provided: a main memory that stores the plurality of pieces of the input data; and a register and a bus for acquiring the plurality of pieces of the input data from the main memory, in which the subtraction unit may be a subtraction circuit that calculates the difference value by acquiring the plurality of pieces of data from the main memory via the register, the divided data generation unit may be a data division circuit, the storage unit may include a register file or a memory that stores the look up table, the acquisition unit may be a look up table reference circuit, and the multiplication unit may be a multiplication circuit.

The subtraction unit may set the common numerical value such that the difference value becomes 0 or less for all of the plurality of pieces of the input data. It is further preferable that the common numerical value is maximum input data among the plurality of pieces of the input data, and the difference value is a value obtained by subtracting the maximum input data from the input data.

Furthermore, the subtraction unit may obtain a subtraction value in which the input data is subtracted from the common numerical value and to subsequently obtain, as the difference value, a value obtained by removing a sign of the subtraction value.

Furthermore, the acquisition unit may acquire an approximate value of an exponential function value stored in a field corresponding to a value of the divided data in the look up table corresponding to the divided data.

Furthermore, it is desirable that the look up table stores all approximate values corresponding to possible values of divided data corresponding to the look up table.

Furthermore, the look up table may store, as the approximate value of the exponential function value corresponding to the divided data, an approximate value of an exponential function value having the divided data as an exponential value.

Furthermore, it is preferable that the exponential function value corresponding to the divided data is an exponential function value having Napier's constant e as a base.

Furthermore, the storage unit may include an approximation calculation unit that calculates, for each of the look up tables, all approximate values corresponding to possible values of divided data corresponding to the look up tables, and stores the calculated approximate values in the look up tables.

Furthermore, it is preferable that the acquisition unit uses the divided data per se as address information of the look up table corresponding to the divided data, and acquire an approximate value of an exponential function value stored in a storage area indicated by the address information from the look up table.

Furthermore, the multiplication unit may include a shift operation unit that performs a shift operation so that the multiplication value becomes a fixed-point number having a predetermined number of bits and a fixed point at a predetermined position. In this case, it is desirable that the shift operation unit performs rounding processing together with the shift operation. In addition, it is preferable that the rounding processing is performed so that the sign of the error generated after the rounding processing does not become only one of positive and negative, and in particular, the rounding processing is rounding off.

Furthermore, a quantization unit that quantizes a plurality of floating-point numbers into an integer or a fixed-point number to generate the plurality of pieces of input data may be included. Here, the plurality of floating-point numbers may be data input to a softmax layer constituting a neural network.

Furthermore, a softmax function approximation calculation method according to one aspect of the present disclosure is a softmax function approximation calculation method of calculating, using a plurality of integers or fixed-point numbers as input data, a softmax function value for each piece of the input data, the softmax function approximation calculation method including: a subtraction step of calculating a difference value between a common numerical value in a plurality of pieces of the input data and the input data; a divided data generation step of generating divided data by slicing the difference value into a predetermined bit width for each piece of the input data; a storage step of storing a plurality of look up tables that are provided corresponding to bit positions of the divided data in the input data that is a source of the divided data and storing an approximate value of an exponential function value corresponding to the divided data as an integer or a fixed-point number; an acquisition step of referring to the look up table corresponding to the divided data according to the divided data and acquiring the approximate value corresponding to the divided data; a multiplication step of calculating a multiplication value of the approximate value corresponding to each piece of the divided data between pieces of the divided data generated by slicing one piece of the input data; and a calculation step of calculating a total value of the multiplication values corresponding to each of the plurality of pieces of the input data and dividing the multiplication value by the total value for each piece of the input data to calculate a softmax function value of the input data.

Furthermore, a softmax function approximation calculation program according to one aspect of the present disclosure is a softmax function approximation calculation program that causes a computer to calculate, using a plurality of integers or fixed-point numbers as input data, a softmax function value for each piece of the input data, the softmax function approximation calculation program causing the computer to execute: a subtraction step of calculating a difference value between a common numerical value in a plurality of pieces of the input data and the input data; a divided data generation step of generating divided data by slicing the difference value into a predetermined bit width for each piece of the input data; a storage step of storing a plurality of look up tables that are provided corresponding to bit positions of the divided data in the input data that is a source of generation of the divided data and storing an approximate value of an exponential function value corresponding to the divided data as an integer or a fixed-point number; an acquisition step of referring to the look up table corresponding to the divided data according to the divided data and acquiring the approximate value corresponding to the divided data; a multiplication step of calculating a multiplication value of the approximate value corresponding to each piece of the divided data between pieces of the divided data generated by slicing one piece of the input data; and a calculation step of calculating a total value of the multiplication value corresponding to each of the plurality of pieces of the input data and dividing the multiplication value by the total value for each piece of the input data to calculate a softmax function value of the input data.

### Advantageous Effects of Invention

In this way, since the range of possible values of the difference value is narrowed by calculating the difference value between the common numerical value in the plurality of pieces of input data and the input data using the subtraction unit, the range of possible values of the exponent of the exponential function used for the softmax function is narrowed, and the size of the look up table storing the approximate value of the exponential function value corresponding to the exponential value can be suppressed.

In addition, when the divided data generated by slicing the difference value to a predetermined bit width is used, the exponential function of the difference value can be calculated by the product of the exponential function values for each piece of the divided data. Therefore, the size of the look up table can be suppressed as compared to conventional techniques in which the approximation accuracy cannot be improved unless the look up table is stored by finely setting the exponential value over the entire range of possible values of the difference value.

Furthermore, in conventional techniques in which a downwardly convex exponential function is approximated by a piecewise linear function, the sign of the error of the piecewise linear function with respect to the exponential function is always positive, whereas in a case where an approximate value is stored in a look up table, the sign of the error of the approximate value with respect to the exponential function value can be prevented from being biased.

### BRIEF DESCRIPTION OF DRAWINGS

FIG. 1 is a diagram illustrating a main system configuration of an image recognition system 1 according to an embodiment of the present disclosure.

FIG. 2 is a block diagram illustrating a main device configuration of an image recognition device 100.

FIG. 3 is a diagram illustrating a configuration of a DCNN 300 used by the image recognition device 100.

FIG. 4 is a hardware configuration diagram illustrating a main hardware configuration of a softmax function approximation calculation device 200.

FIG. 5 is a data flow diagram schematically illustrating a flow of approximation calculation of a softmax function value in the softmax function approximation calculation device 200.

FIG. 6 is a diagram illustrating processing of slicing a difference value a into three bit fields of upper 4 bits, middle 4 bits, and lower 3 bits.

FIG. 7(a) is a diagram illustrating a procedure of reading an approximate value of an exponential function value from a look up table using bit fields of the lower 3 bits as an example, and FIG. 7(b) is a diagram illustrating an exemplary table configuration of look up tables table1 and table2 respectively corresponding to bit fields of the upper 4 bits and middle 4 bits.

FIG. 8(a) is a diagram illustrating that the number of bits of a fixed-point number representing a multiplication value obtained by multiplying approximate values of exponential function values represented by the fixed-point number is larger than the number of bits of the fixed-point number representing the approximate value, and FIG. 8(b) is a diagram illustrating rounding processing of the multiplication value and a right shift operation performed to align the number of bits with the fixed-point number representing the approximate value.

FIG. 9(a) is a diagram illustrating processing of initializing the look up table table1 corresponding to the upper 4 bits of the difference value a, and FIG. 9(b) is a diagram illustrating processing of initializing the look up table table2 corresponding to the middle 4 bits of the difference value a.

FIG. 10 is a diagram illustrating processing of initializing a look up table table3 corresponding to the lower 3 bits of the difference value a.

FIG. 11 is a diagram illustrating an example of a look up table for specifying, for each section, a piecewise linear function that approximates an exponential function according to a conventional technique.

FIG. 12 is a flowchart illustrating a flow of processing of a softmax function approximation calculation method and a softmax function approximation calculation program according to a modification of the present disclosure.

FIG. 13 is a graph illustrating that signs of errors are positively biased by exemplifying a piecewise linear function for approximating an exponential function.

### DESCRIPTION OF EMBODIMENT

Hereinafter, an embodiment of a softmax function approximation calculation device, an approximation calculation method, and an approximation calculation program according to the present disclosure will be described with reference to the drawings, taking an image recognition system as an example.

[1] Configuration of Image Recognition System

First, a configuration of an image recognition system according to the present embodiment will be described.

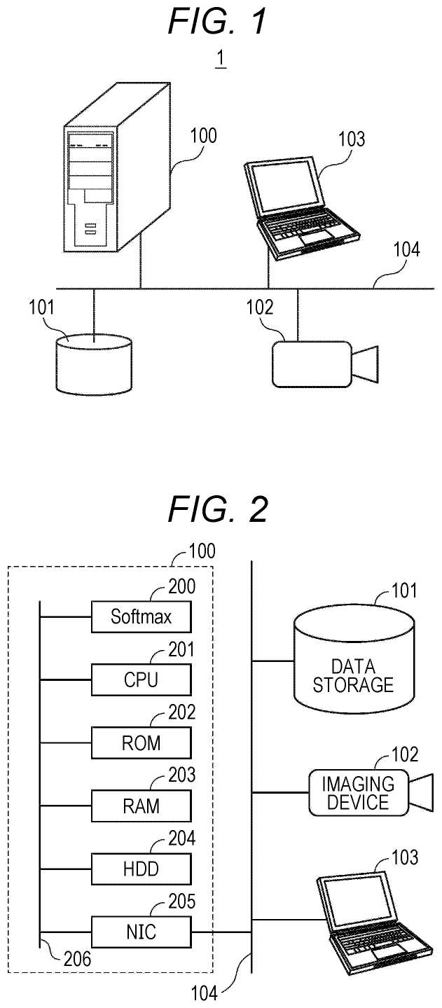

As illustrated in FIG. 1, in an image recognition system 1, an image recognition device 100, a data storage 101, an imaging device 102, and a terminal device 103 are connected by a communication network 104. The imaging device 102 generates image data by capturing an image of a target of image recognition processing. The image data generated by the imaging device 102 may be a still image or a moving image, and is stored in the data storage 101.

The image recognition device 100 is a so-called server device, and reads image data from the data storage 101 and executes image recognition processing using a deep-learning convolutional neural network (DCNN), which is a convolutional neural network (CNN) that has performed deep learning. The terminal device 103 is used to operate the image recognition device 100 to execute image recognition processing and refer to a processing result of image recognition.

[2] Configuration of Image Recognition Device 100

As illustrated in FIG. 2, the image recognition device 100 has a configuration in which a softmax function approximation calculation device 200, a central processing unit (CPU) 201, a read only memory (ROM) 202, and the like are communicably connected to each other via an internal bus 206. When a reset signal is input by, for example, turning on power to the image recognition device 100, the CPU 201 reads a boot program from the ROM 202 and activates the boot program, and executes an image recognition processing program by an operating system (OS) read from a hard disk drive (HDD) 204 or the DCNN using a random access memory (RAM) 203 as a working storage area.

A network interface card (NIC) 205 executes processing for communicating with the data storage 101 and the terminal device 103 via the communication network 104.

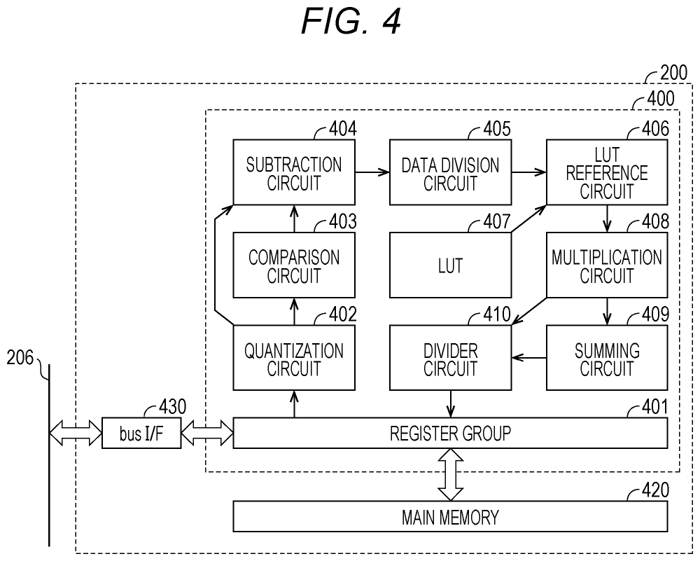

The softmax function approximation calculation device 200 is an electronic circuit that executes approximation calculation of a softmax function necessary when the image recognition device 100 executes an image recognition program by the DCNN. The softmax function approximation calculation device 200 may be a circuit board or a circuit element such as a field-programmable gate array (FPGA) 400 as illustrated in FIG. 4.

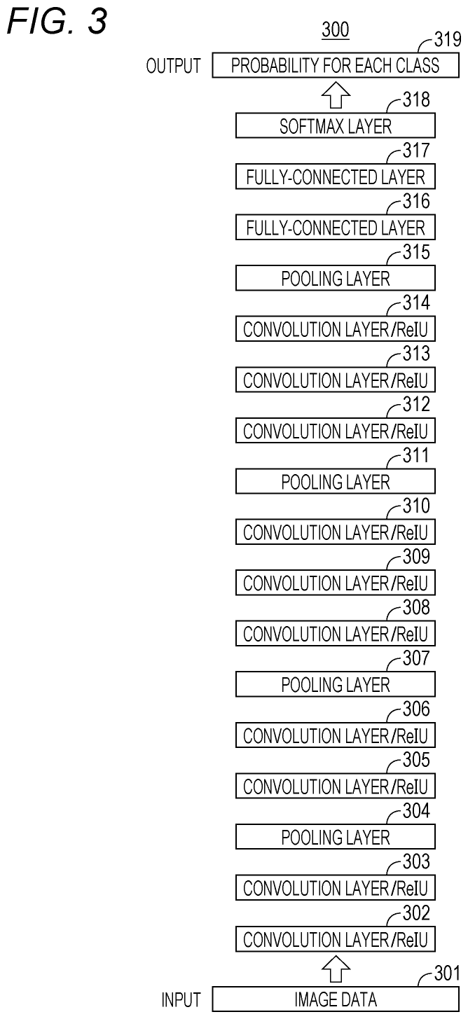

In the present embodiment, as illustrated in FIG. 3, the image recognition device 100 uses a DCNN 300 including seventeen layers 302 to 318 that receive vector-represented image data as an input 301 and output a probability 319 of which class the image data corresponds for each class.

Convolution layers/RelUs 302, 303, 305, 306, 308 to 310, and 312 to 314 are convolution layers using a rectified linear unit (RelU) as an activation function, and extract features from data input to each layer. Pooling layers 304, 307, 311, and 315 compress the output data of the convolutional layers/RelUs 303, 306, 310, and 314. As a result, it is possible to implement image recognition resistant to positional deviation.

Fully-connected layers 316 and 317 classify the original image data using the output data of the pooling layer 315. The softmax layer 318 calculates the probability for each class from the output data of the fully-connected layer 317 using the softmax function. In this case, the image recognition device 100 inputs the output data of the fully-connected layer 317 to the softmax function approximation calculation device 200, and acquires the output of the softmax function approximation calculation device 200 with respect to the input, thereby obtaining the probability for each class.

[3] Configuration and Operation of Softmax Function Approximation Calculation Device 200

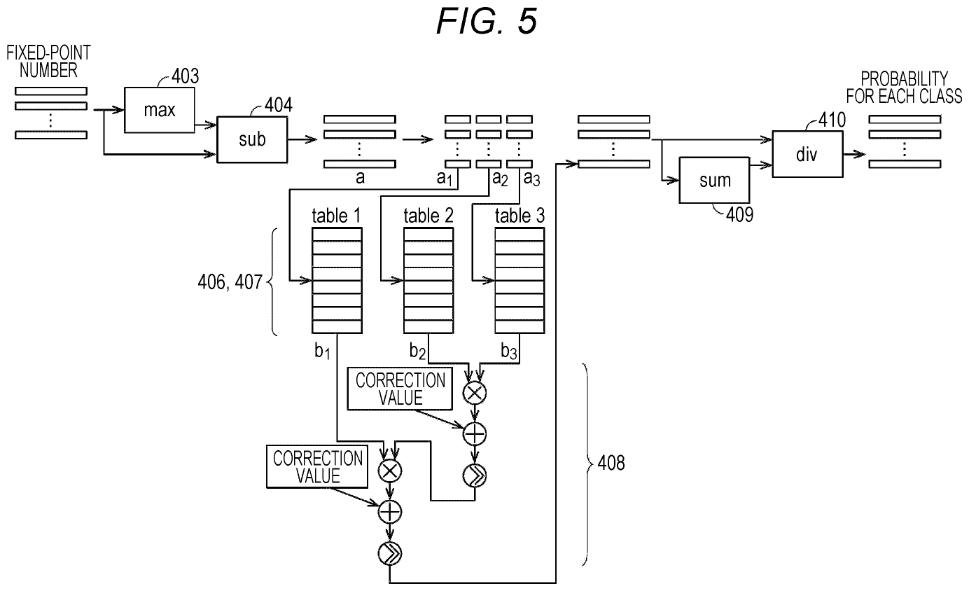

As illustrated in FIG. 4 and FIG. 5, the softmax function approximation calculation device 200 includes a bus interface 430 for connecting to the internal bus 206 of the image recognition device 100, and uses the bus interface 430 to receive output data of the fully-connected layer 317 and output an approximation calculation result of the softmax function.

When the output data of the fully-connected layer 317 includes data that does not correspond to any class of the image, the softmax function approximation calculation device 200 may receive only the output data corresponding to each class of the image among the output data of the fully-connected layer 317. In a case where an error may occur in the probability by class of the image by receiving even the output data not corresponding to any class of the image and performing the approximation calculation of the softmax function, excluding unnecessary output data is effective for allowing improvement of the calculation accuracy of the probability.

In a case of receiving the output data of the fully-connected layer 317, the softmax function approximation calculation device 200 designates, for example, an address indicating a storage area in which the output data of the fully-connected layer 317 on the RAM 203 is stored and receives a command requesting approximation calculation of the softmax function. The softmax function approximation calculation device 200 may subsequently read the output data of the fully-connected layer 317 from the designated address on the RAM 203 using the bus interface 430 and write the read output data in a main memory 410 as input data.

In addition, the CPU 201 may access a register group 401 of the softmax function approximation calculation device 200 to write the output data of the fully-connected layer 317 into a main memory 420 of the softmax function approximation calculation device 200 and request the approximation calculation of the softmax function.

In the present embodiment, the input data output by the fully-connected layer 317 and received by the softmax function approximation calculation device 200 is a floating-point number, and a quantization circuit 402 executes quantization processing for converting the input data of the floating-point number into data of a fixed-point number. Note that, in the present embodiment, a case where the data is converted into data of a fixed-point number will be described as an example. However, it goes without saying that the data may be converted into data of an integer instead of the data of a fixed-point number, to execute the subsequent processing.

Furthermore, in the present embodiment, a case where the data is quantized into data of a 12 bit fixed-point number will be described as an example, but it goes without saying that the number of bits of the quantized data of the fixed-point number is not limited to 12 bits, and other numbers of bits may be used.

Next, the comparison circuit 403 compares the data of the fixed-point number output from the quantization circuit 402 with each other, and specifies the data of the maximum fixed-point number (data of the maximum value). A subtraction circuit 404 subtracts the maximum value from each data. The softmax function is a nonlinear function represented using an exponential function having Napier's constant e as a base as in the following Formula (1).

$$\begin{matrix}[ Mathematical Formula 1 ] & \\ {softmax ( {x}_{1} , {x}_{2} , … , {x}_{N} )}_{i} = \frac{{e}^{{x}_{i}}}{{\sum }_{j = 1}^{N} {e}^{{x}_{j}}} , & ( 1 )\end{matrix}$$

$$( i = 1 , 2 , … , N )$$

Therefore, even if a common bias value k is subtracted from all variables x₁, x₂, . . . , and x_{N} to obtain (x₁−k), (x₂−k), . . . , and (x_{N}−k), the function value of the softmax function does not change as illustrated in the following Formula (2).

$$\begin{matrix}[ Mathematical Formula 2 ] & \\ \begin{matrix}{softmax ( {x}_{1} - k , {x}_{2} - k , … , {x}_{N} - k )}_{i} = \frac{{e}^{( {x}_{i} - k )}}{{\sum }_{j = 1}^{N} {e}^{( {x}_{j} - k )}} \\ = \frac{{e}^{- k} \cdot {e}^{{x}_{i}}}{{e}^{- k} \cdot {\sum }_{j = 1}^{N} {e}^{{x}_{j}}} \\ = \frac{{e}^{{x}_{i}}}{{\sum }_{j = 1}^{N} {e}^{{x}_{j}}} \\ = {softmax ( {x}_{1} , {x}_{2} , … , {x}_{N} )}_{i}\end{matrix} & ( 2 )\end{matrix}$$

Therefore, even if the subtraction circuit 404 calculates the function value of the softmax function using the difference value obtained by subtracting the maximum value from each data, the calculated function value is the same as the function value of the softmax function calculated using the original data without subtracting the maximum value.

In addition, the difference values obtained by subtracting the maximum value from each data are all 0 or less. Therefore, all the exponential function values having the difference value as an exponent are 0 or more and 1 or less.

A data division circuit 405 slices a difference value obtained by subtracting the maximum value from each data to a predetermined bit width. When a difference value is a and divided values obtained by the slicing are a₁, a₂, and a₃,

[Mathematical Formula 3]

a=a₁+a₂+a₃ (3)

is established. The exponential function can also rewrite the exponential function of the sum of the exponents to the product of the exponential functions according to the exponential law. That is,

[Mathematical Formula 4]

e^{a}=e^{(a}^{₁}^{+a}^{₂}^{+a}^{₃}⁾=e^{a}^{₁}·e^{a}^{₂}·e^{a}^{₃} (4)

is established, and therefore, the exponential function value having the difference value a as an exponent is equal to the product of the exponential function values having the divided values a₁, a₂, and a₃ as exponents.

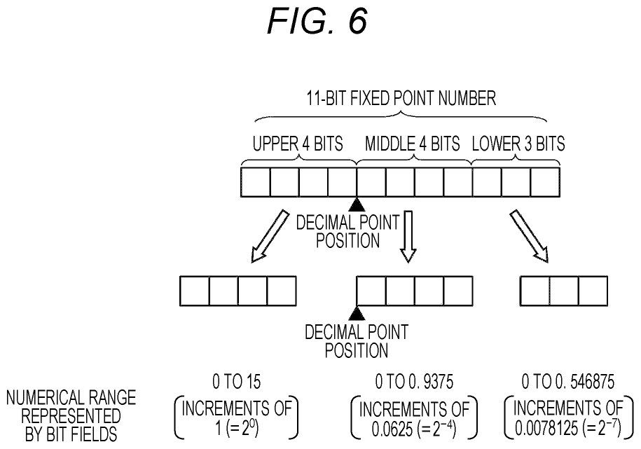

When description is made taking as an example the fixed-point number having the upper 4 bits as the integer part and the lower 7 bits as the fractional part among 11 bits excluding the most significant bit of the fixed-point numbers of 12 bits in which the most significant bit represents the sign, as illustrated in FIG. 6, the 11 bits excluding the most significant bit representing the sign can be divided into three bit fields of the upper 4 bits, the middle 4 bits, and the lower 3 bits.

The 12 bit fixed-point number corresponds to the difference value a, and the three bit fields correspond to the divided values a₁, a₂, and a₃, respectively. In addition, since the difference value a always takes a value of 0 or less, the most significant bit always has a value representing a negative value.

The upper 4 bits can represent the divided value a₁ from “0” to “15” in increments of “2°”, that is, “1”, and the middle 4 bits can represent the divided value a₂ from “0” to “0.9375” in increments of “2⁻⁴”, that is, “0.0625”. Furthermore, the lower 3 bits can represent the divided value a₃ from “0” to “0.546875” in increments of “2-?”, that is, “0.0078125”.

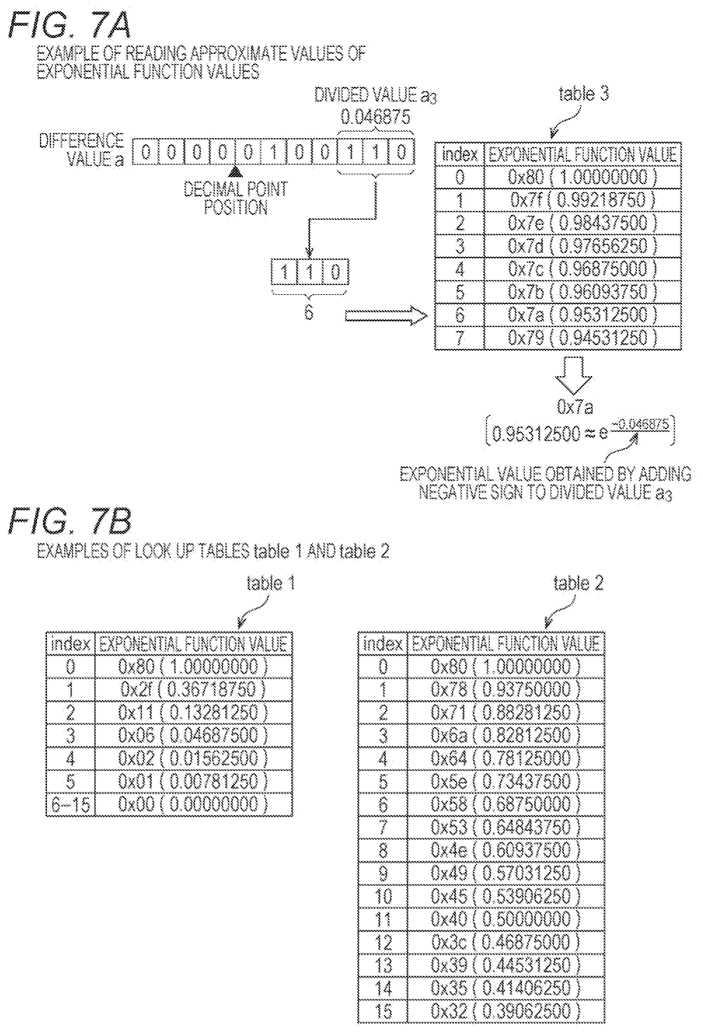

A look up table (LUT) reference circuit 406 reads the values of the bit fields of the upper 4 bits, the middle 4 bits, and the lower 3 bits by replacing them with bit fields each representing an integer. For example, as illustrated in FIG. 7, when the lower 3 bits are 0b110, the divided value a₃ is “0.046875”, but the look up table reference circuit 406 interprets this as “6”, and sets an approximate value of an exponential function value having, as an exponent, a value “−0.046875” obtained by adding a negative sign as a sign to the divided value a₃ “0.046875”, to an index to read from the look up table table3.

In FIG. 5, as the look up table 407, three look up tables table1, table2, and table3 are described corresponding to the bit fields of the upper 4 bits, the middle 4 bits, and the lower 3 bits of the difference value a. The approximate value of the exponential function value corresponding to the index “6” of the look up table table3 corresponding to the lower 3 bits is “0x7a”.

The look up table 407 is divided into look up tables table1, table2, and table3 for each of the divided values a₁, a₂, and a₃, and stores an approximate value of the exponential function value (hereinafter, the “approximate value of the exponential function value” is simply referred to as an “exponential function value”) having the divided values a₁, a₂, and a₃ as exponential values. The look up tables table1, table2, and table3 store exponential function values for all possible values of the divided values a₁, a₂, and a₃, respectively.

When the look up table reference circuit 406 reads, from the look up tables table1, table2, and table3, exponential function values b₁, b₂, and b₃ having exponential values obtained by adding negative signs to the divided values a₁, a₂, and a₃, respectively, a multiplication circuit 408 multiplies the exponential function values b₁, b₂, and b₃.

In the example of FIG. 5, the multiplication circuit 408 first multiplies the exponential function values b₂ and b₃. In a case where the exponential function value stored in the look up table 407 is 8-bit data, the number of bits required to represent the multiplication value of the exponential function values b₂ and b₃ increases to be 16-bit data. When the 8-bit exponential function value b₁ is multiplied by the 16-bit data as it is, the number of bits further increases to 24 bits.

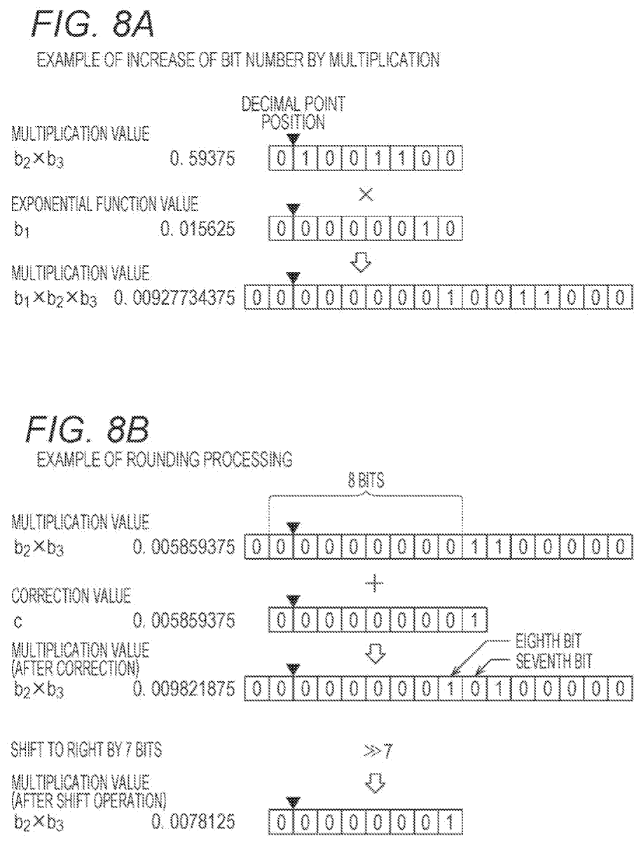

When the number of bits increases in this manner, a processing load and a storage capacity required for calculation increase, which is not preferable. Therefore, in the present embodiment, a right shift operation is performed every time the multiplication is performed. The example of FIG. 8(a) illustrates a case where the multiplication value (2b01001100=0.59375) of the exponential function values b₂ and b₃ is multiplied by the exponential function value b₁ (2b00000010=0.015625).

The multiplication value of the exponential function values b₂ and b₃ becomes 8-bit data through the right shift operation. The exponential function value b₁ is also 8-bit data. Since the multiplication value b₁×b₂×b₃ of the multiplication value of the exponential function values b₂ and b₃ and the exponential function value b₁ becomes 16-bit data, the data is further converted into 8-bit data by the right shift operation. Since an error may occur when such a right shift operation is performed, rounding off is also performed as the rounding processing in the present embodiment.

FIG. 8(b) illustrates rounding processing for converting a 16-bit multiplication value b₂×b₃ (0b0000000001100000=0.005859375) into 8 bits. When a 7-bit right shift operation is performed on 16-bit data (0b0000000001100000) as it is, 0b00000000 (=0) is obtained, so that an error from the original multiplication value is −0.005859375.

On the other hand, when a correction value (0b000000001=2⁷+1=0.00390625) in which only the least significant bit is set to 1 and the other bits are set to 0 in 9-bit data, which is one bit more than 8 bits, which are the number of bits after the rounding processing, is added to the 16 bit-data, 0b0000000010100000 is obtained, and the 7th bit is rounded off to obtain the 8th bit of 1.

When the 7-bit right shift operation is performed on the 16-bit data rounded off as described above, the result is 0b00000001 (=0.0078125), and the error from the original multiplication value is 0.001953125, which is smaller than that in a case where the data is not rounded off. The multiplication circuit 408 calculates the multiplication value from the exponential function value read from the look up table 407 as described above.

A summing circuit 409 adds the multiplication value calculated for each piece of input data to calculate a total value. A divider circuit 410 calculates an approximate value of the softmax function value by dividing the multiplication value calculated for each piece of input data by the total value calculated by the summing circuit 409. The approximate value of the calculated softmax function value corresponds to the probability 319 for each class output by the softmax layer 318.

After completing the calculation of the softmax function value for all the input data, the softmax function approximation calculation device 200 may notify the CPU 201 of the completion. The calculated softmax function value may be stored in the main memory 420 and read by the CPU 201 via the internal bus 206. In addition, prior to the above completion notification, the softmax function value may be stored in a designated area on the RAM 203.

[4] Comparison Circuit 403 and Subtraction Circuit 404

In the above, description has been made to the case where the maximum value specified by the comparison circuit 403 from the data output by the quantization circuit 402 is used as the bias value k to be subtracted from each data in Formula (2). However, it goes without saying that the present disclosure is not limited to such a case, and a value other than the maximum value may be used as the bias value k.

For example, even in a case where a value larger than the maximum value is used as the bias value k, signs of the difference values a calculated by the subtraction circuit 404 are all negative, and thus, it is possible to read an approximate value of an exponential function value from the look up table 407 using a portion other than the sign in the fixed-point number.

In addition, the minimum value specified by the comparison circuit 403 from the data output from the quantization circuit 402 may be used as the bias value k. In this case, the signs of the difference values a calculated by the subtraction circuit 404 are all positive, but as in the case where the signs of the difference values a are all negative, an approximate value of an exponential function value can be read from the look up table 407 using a portion other than the sign in the fixed-point number. The same applies to a case where a value smaller than the minimum value is used as the bias value k.

In a case where a value smaller than the maximum value and larger than the minimum value of the data output from the quantization circuit 402 is used as the bias value k, it is necessary to properly use the look up table 407 according to the sign of the difference value a. That is, both the look up table 407 used when the sign of the difference value a is positive and the look up table 407 used when the sign of the difference value a is negative are prepared, and the look up table 407 may be used differently according to the sign of the difference value a.

Furthermore, it goes without saying that the order of subtraction by the subtraction circuit 404 is not limited to such a case of subtracting the bias value k from the data output by the quantization circuit 402, and each data may be subtracted from the bias value k. Even in this case, when the bias value k at which the sign of the difference value a is constant is used, the look up table 407 can be referred to regardless of the sign of the difference value a. However, in this case, the approximate value of the exponential function value stored in the look up table 407 is an approximate value of an exponential function value having a numerical value obtained by inverting the sign of the difference value a as an exponent.

In addition, in a case where each data is subtracted from the bias value k at which the sign of the difference value a is not constant, it is necessary to prepare the look up table 407 according to the sign of the difference value a. In this case, the correspondence relationship between the difference value a for each sign and the look up table 407 is reversed as compared to the case of subtracting the bias value k in which the sign of the difference value a is not constant from each data.

[5] Initialization of Look Up Table 407

Next, as initialization processing of the look up table 407, processing of storing an approximate value of an exponential function value will be described in detail.

Note that, in the present embodiment, as described above, regarding the fixed-point number having the upper 4 bits as the integer part and the lower 7 bits as the fractional part among the 11 bits excluding the most significant bit of the fixed-point numbers of 12 bits in which the most significant bit represents the sign, description is made taking as an example the case where the 11 bits excluding the most significant bit representing the sign are divided into three bit fields of the upper 4 bits, the middle 4 bits, and the lower 3 bits. However, instead of the fixed-point number data, integer data may be used, or the number of bits may be other than 12 bits. In addition, the data may be divided into two bit fields, or may be divided into four or more bit fields. Furthermore, the number of bits of each bit field is not limited to the above.

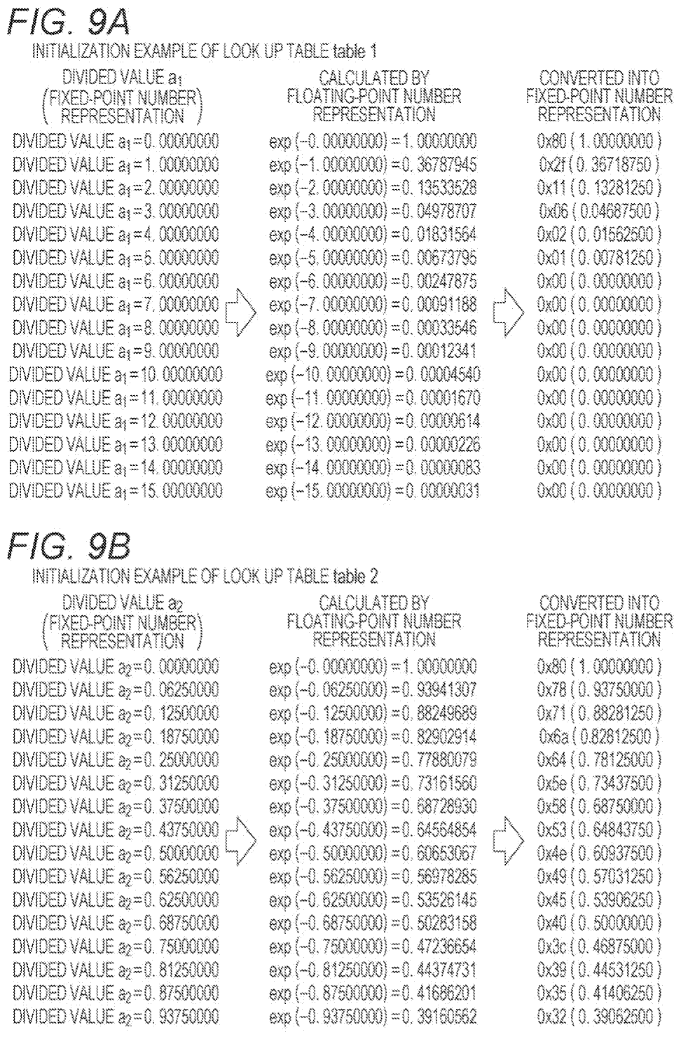

In the present embodiment, as described above, in the upper 4 bits, the divided value a₁ from “0” to “15” is represented in increments of “2°”, that is, “1”, and thus, in the initialization of table1, an approximate value of an exponential function value having 16 numerical values from “0” to “15” as exponents is stored. Specifically, as illustrated in FIG. 9(a), after an approximate value of an exponential function value having each divided value a₁ as an exponent is calculated by floating-point number representation, each approximate value is converted into fixed-point representation and stored in the look up table table1, thereby initializing the look up table table1.

The middle 4 bits represent the divided value a₂ from “0” to “0.9375” in increments of “2⁻⁴” in correspondence with the decimal point position in the original 12-bit data. Therefore, in the initialization of table2, as illustrated in FIG. 9(b), after an approximate value of an exponential function value having these 16 numerical values as an exponent is calculated by the floating-point representation, each approximate value is converted into the fixed-point representation and stored in the look up table table2.

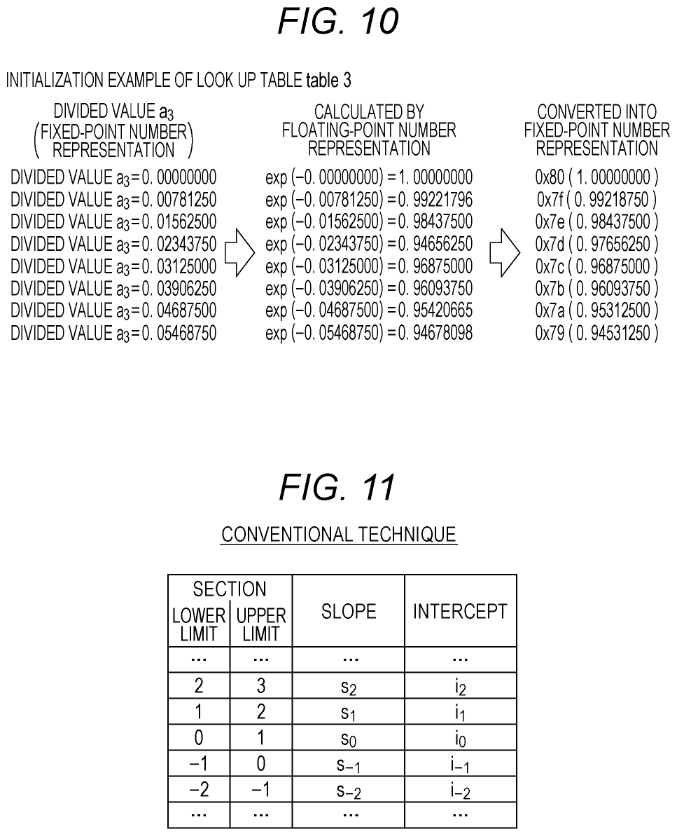

As illustrated in FIG. 10, in the initialization of table3, the approximate value of the exponential function value having the exponent of 8 numerical values obtained by representing the divided values a₃ from “0” to “0.546875” in increments of “2⁻⁷” is calculated in the floating-point representation by the lower 3 bits corresponding to the decimal point position in the original 12-bit data, then each approximate value is converted into the fixed-point representation, and stored in the look up table table3.

In the present embodiment, description is made taking a case where the fixed-point number to be stored in the look up tables table1, table2, and table3 is 8 bits as an example, but it goes without saying that the fixed-point number may be other than 8 bits as long as accuracy required for calculating the probability for each class can be secured.

Furthermore, in the present embodiment, since the maximum value is subtracted from each data in the subtraction circuit 404 to a value of 0 or less, and the exponential function value is a value of 1 or less, only the most significant bit of the 8 bits represents an integer value of “1” or “0”, and a decimal point is between the most significant bit and the second most significant bit. However, it goes without saying that the present disclosure is not limited to such a decimal point, and other positions may be decimal points.

When an approximate value of an exponential function value is converted from the floating-point representation to the fixed-point representation, rounding processing is required. It is desirable that the sign of the error between the approximate value and the true value is not biased to either positive or negative by this rounding processing, and for example, rounding processing can be performed as rounding off. In particular, rounding off is effective because the look up table table3 has a small approximate value and the influence of rounding processing on the error of the approximate value tends to be large.

In addition, the manner of rounding processing may be changed in the look up tables table1, table2, and table3. For example, as rounding processing, when the sign of the error is always positive by rounding up in the look up table table1, the sign of the error is always negative by rounding down in the look up table table2, and the sign of the error is either positive or negative by rounding off in the look up table table3, it is possible to prevent the sign of the error in the case of multiplying them from being biased to either positive or negative.

The initialization processing of the look up table 407 may be performed when the image recognition device 100 is powered on, or may be performed at the time of factory shipment. In addition, the look up table 407 may be initialized at timing to designate bit fields of how many bits the input data of an integer or a fixed-point number is to be divided into. The initialized look up table 407 is desirably stored in a nonvolatile memory.

How many bits of integer or fixed-point number the output data of the fully-connected layer 317 is quantized may be changed by receiving designation using the terminal device 103 or the like. In addition, designation of bit fields of how many bits the quantized data is to be divided into may be accepted regardless of whether the number of bits after quantization has been changed.

[6] Look Up Table Reference Circuit 406

When referring to the look up table 407, the look up table reference circuit 406 interprets that the bit fields of the upper 4 bits, the middle 4 bits, and the lower 3 bits each represent an integer value, and uses the integer value as address information in the look up tables table1, table2, and table3 to read an approximate value of an exponential function value stored in a storage area indicated by the address information. As illustrated in FIG. 7, a case where the lower 3 bits are “110” represents, as an exponential value, a decimal value “0.046875” with respect to the decimal point position of the difference value a, while the lower 3 bits themselves represent an integer value “6”.

When referring to the look up table table3 corresponding to the bit field of the lower 3 bits, the look up table reference circuit 406 reads an approximate value of an exponential function value having an integer value “6” indicated by the bit field as address information. Since the 8-bit fixed-point number is sequentially stored in the look up table table3, 8-bits data may be read that is stored in the address (address+48) to which

8 bits×6=48 bits

is added to the first address (address) of the look up table table3.

In the example of FIG. 7, “0x7a” is stored in the address, and the decimal point position is between the most significant bit and the next bit, so that the fixed-point number “0.95312500” is read as an approximate value of the exponential function value. The same applies to other bit fields and lookup tables.

[7] Comparison with Conventional Techniques

In the conventional technique described in Non Patent Literature 1, in order to approximate an exponential function value using a piecewise linear function, as illustrated in FIG. 11, it is necessary to designate a section of an exponent by a lower limit value and an upper limit value of the exponent and store a slope and an intercept of the piecewise linear function in the section in a look up table.

Since the error between the piecewise linear function value and the exponential function value is particularly large at the center of the section, it is necessary to narrow the section in order to reduce the error. In particular, since the error increases in a section in which the slope of the exponential function is large, the section needs to be particularly narrowed. For example, when 0 to 15.9921875 are divided into sections with a width of 0.0078125 (=2⁻⁷) and the slope and intercept of the piecewise linear function are stored, the number of sections is 2048 (=2¹¹). Since the slope and the intercept are stored for each section, the number of numerical values to be stored reaches 4096.

On the other hand, in the present embodiment, since the maximum value is specified from the input data obtained by quantizing the output data of the fully-connected layer 317 and the difference value a obtained by subtracting the maximum value from each piece of input data is used, the range of the exponent is narrowed. Further, the difference value a is divided into a plurality of bit fields, and an approximate value of an exponential function value is read from the look up table for each bit field. Therefore, in the present embodiment, the approximate values of the exponential function values stored in the look up tables table1, table2, and table3 corresponding to the bit fields of the upper 4 bits, the middle 4 bits, and the lower 3 bits are 16, 16, and 8, respectively.

This is 40 in total, and even if the range of the same exponent is divided into the same width, it is less than 1/100 compared to the above-described conventional technique. In the present embodiment, considering that the range of the exponent is narrowed by subtracting the maximum, the size of the look up table can be further reduced as compared to the above-described conventional technique.

In addition, as described above, by performing the rounding processing, the sign of the error of the approximate value of the exponential function value becomes both positive and negative, and thus, the sign of the error is not biased to positive as in the above-described conventional technique. Therefore, the problem caused by the deviation of the sign of the error can be avoided.

[8] Modifications

Although the present disclosure has been described based on the embodiment, it is needless to say that the present disclosure is not limited to the above-described embodiment, and the following modifications can be implemented.

(8-1) In the above embodiment, the case where the softmax function approximation calculation device 200 is an electronic circuit has been described as an example. However, it goes without saying that the present disclosure is not limited to such a case, and instead of the electronic circuit, a computer equipped with a softmax function approximation calculation program for executing a softmax function approximation calculation method may be used.

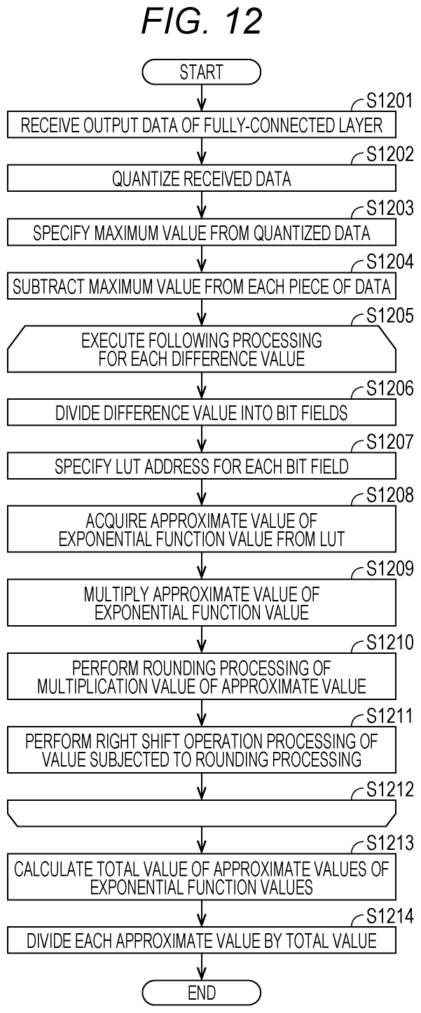

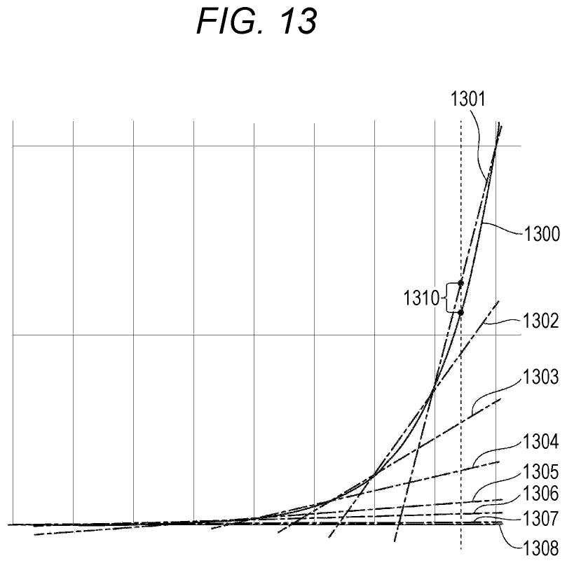

As illustrated in FIG. 12, when receiving the output data of the fully-connected layer 317 (S1201), the computer quantizes each output data (S1202). As in the above embodiment, the output data may be an integer or a fixed-point number by this quantization.

Next, the quantized data is compared to specify a maximum value (S1203), and the maximum value is subtracted from each piece of data to obtain a difference value a (S1204). As in the above embodiment, the value to be subtracted from each data may be a value other than the maximum value. When the maximum value is subtracted from each data, the difference values a obtained after the subtraction are all 0 or less.

Thereafter, the processing from step S1205 to step S1212 is executed for each difference value a. That is, the difference value a is divided into a plurality of bit fields (S1206), the value of the bit field is set as address information by referring to a look up table corresponding to each bit field (S1207), and an approximate value of an exponential function value stored in a storage area corresponding to the address information in the look up table is read (S1208). The look up table according to the present modification may have a configuration similar to that of the above-described embodiment, and an approximate value of an exponential function expressed by a fixed-point number is stored.

When the approximate value of the exponential function value is read from the look up table for each bit field, the bit fields are multiplied by the approximate value of the exponential function value (S1209). Since the number of bits of the multiplication value obtained by this multiplication is larger than the approximate value of the original exponential function value, rounding processing is performed (S1210), and then a rightward shift operation is performed so as to obtain a fixed-point number having the same number of bits as the approximate value of the original exponential function value (S1211). As a result, an approximate value of an exponential function value having the difference value a as an exponent is calculated.

When the approximate values of the exponential function values have been calculated for all the difference values a, a total value of the approximate values is calculated (S1213). In parallel with the calculation of the approximate value of the exponential function value for each difference value a, the total value may be calculated by sequentially adding the approximate values. Finally, by dividing the approximate value of the exponential function value by the total value for each difference value a (S1214), the probability of the class corresponding to the difference value a can be obtained.

(8-2) In the above embodiment, the case where the softmax function approximation calculation device 200 is mounted on the image recognition device 100 that is a server device has been described as an example. However, it goes without saying that the present disclosure is not limited to such a case, and the image recognition processing by the DCNN may be executed by incorporating the softmax function approximation calculation device 200 in the imaging device 102 instead of the server device.

The imaging device 102 may be fixedly installed like a monitoring camera or the like of a plant or the like, or may be carried like an in-vehicle camera or the like. In a case where a large number of imaging devices 102 are used, if the image recognition by the DCNN is intensively processed, the processing load may concentrate on the image recognition device 100 and the processing may be delayed, or the execution frequency of the image recognition processing may have to be reduced.

On the other hand, since an Internet of Things (IoT) device such as the imaging device 102 does not have higher processing performance than a server device, it is difficult to obtain sufficient processing performance when the processing load of the DCNN is high. The same applies to a case where small size and light weight are required for carrying such as an in-vehicle camera. However, in order to obtain sufficient approximation accuracy using a method of approximating an exponential function with a piecewise linear function as in the conventional technique, a storage capacity required for storing a look up table becomes too large, which is not realistic.

For such a problem, if the softmax function approximation calculation device 200 is mounted on the imaging device 102, it is possible to reduce the processing load of the DCNN in the imaging device 102 while suppressing the size of the look up table required to approximate the exponential function with high accuracy, and thus, it is possible to achieve sufficient processing performance for executing the image recognition processing.

In addition, not only the imaging device 102 but also any device that acquires an image by any units, such as an imaging unit or a unit other than imaging, and performs processing by a neural network including a softmax layer can obtain a similar effect by mounting the softmax function approximation calculation device 200.

(8-3) In the above embodiment, the case where the DCNN is used as the neural network has been described as an example. However, it goes without saying that the present disclosure is not limited to such a case, and even a neural network other than the DCNN can suppress the size of the look up table used to perform approximation calculation of the exponential function by the processing in the softmax layer by applying the present disclosure as long as the neural network has the softmax layer.

(8-4) The softmax function uses Napier's constant e as a base of the exponential function. However, even in a case where approximation calculation of an exponential function having a base of a number other than Napier's constant e is performed, a magnitude relationship of probabilities calculated in the same manner as in the softmax function using the exponential function value among image classes matches a magnitude relationship of a softmax function value calculated using Napier's constant e as a base.

According to the present disclosure, even when approximation calculation of an exponential function having a base of a number other than Napier's constant e is performed, it is only necessary to change an approximate value of the exponential function to be stored in the look up table, so that the size of the look up table can be easily suppressed. Therefore, naturally, an approximation calculation device, an approximation calculation method, and an approximation calculation program of a function similar to a softmax function using an exponential function having a number other than Napier's constant e as a base are also included in the technical scope of the present disclosure.

(8-5) In the above embodiment, the case where the approximate value of the exponential function value to be stored in the look up table is 8 bits has been described as an example. However, it goes without saying that the present disclosure is not limited to such a case, and the number of bits may be other than 8 bits. When classification of an image into classes is performed using the DCNN, it is sufficient that a difference between a probability of a class to which the image corresponds and a probability of a class to which the image does not correspond is sufficiently large, and it is not always required to calculate a probability value by class of the image with high accuracy. Therefore, the number of bits may be less than 8 bits as long as the difference in the probability values between the image classes can be sufficiently increased.

(8-6) In the above embodiment, the multiplication circuit 405 constituting the softmax function approximation calculation device 200 may be implemented, for example, by the look up table reference circuit 406 referring to a data wiring through which the difference value a is transmitted from the subtraction circuit 404 to the look up table reference circuit 406 for each bit field.

For example, as in the above embodiment, in a case where the difference value a is represented by a 12-bit fixed-point number, the look up table reference circuit 406 refers to the data signal for each of the upper 4, middle 4, and lower 3 data wirings corresponding to the upper 4 bits, the middle 4 bits, and the lower 3 bits, respectively, so that an approximate value of an exponential function value corresponding to the data signal can be read in the look up tables table1, table2, and table3.

(8-7) In the above embodiment, description has been made taking as an example the case where the approximate values of the exponential function values are stored in the look up tables table1, table2, and table3 for all the possible difference values a₁, a₂, and a₃ in the upper 4 bits, the middle 4 bits, and the lower 3 bits. However, it goes without saying that the present disclosure is not limited to such a case. In a case where there is a difference value that is known to be unnecessary in advance, for example, in a case where an integer represented by the upper 4 bits of the difference value a cannot be 15, a field corresponding to the integer value 15 may not be stored in the look up table table1. In this way, the size of the look up table 407 can be further reduced.

(8-8) Non Patent Literature 2 is a literature related to a calculation method of initial integration “0” (m) in a molecular orbital dedicated computer MOEngine, and in the “2.2 Exponential Function”, a domain of an argument S of an exponential function is determined from an absolute minimum floating-point number that can be represented when an underflow value substantially conforms to Institute of Electrical and Electronics Engineers (IEEE). For this reason, if the approximation calculation method of the exponential function value described in Non Patent Literature 2 is applied as it is, the size of the look up table cannot be sufficiently reduced.

On the other hand, in the present disclosure, focusing on the fact that the calculation accuracy as in the molecular orbital calculation is not required in the approximation calculation of the softmax function in the neural network, the output data of the fully-connected layer 317 to be input to the softmax layer 318 is quantized and converted into an integer or a fixed-point number prior to the calculation of the softmax function value.

In this way, since the domain of the exponential function can be narrowed as compared to the case where the domain of the argument S of the exponential function is determined from the absolute minimum floating-point number as in Non Patent Literature 2, the size of the look up table can be reduced as compared to the approximation calculation method of the exponential function value described in Non Patent Literature 2.

In Non Patent Literature 2, approximation calculation of an exponential function value is performed for each argument S of the exponential function. If this manner is applied as it is, the approximate value of the exponential function value related to the softmax function is calculated for each piece of input data. Therefore, in a case where the upper limit of the distribution range of the input data of the softmax function is a positive value, it is necessary to prepare a look up table for the positive input data.

In addition, when the upper limit of the distribution range of the input data is less than 0, the lower limit value of the distribution range of the input data exceeds the size of the distribution range and becomes a value away from 0, and thus such a value also needs to be included in the look up table.

On the other hand, by using a property that can be said to be a kind of shift invariance in the softmax function as shown in Formula (2) described in the above embodiment, the softmax function value can be calculated even using a value obtained by subtracting the maximum value from each piece of input data. Then, when the maximum value is subtracted from the input data of the softmax function, the upper limit of the distribution range of the difference value is always 0 (a value obtained by subtracting the maximum value from the minimum value of the input data), and thus it is not necessary to prepare a look up table in consideration of a case where the difference value becomes positive.

In addition, since the lower limit of the distribution range of the difference value is a value far from 0 by the size of the distribution range, a value far from 0 (for example, a field corresponding to the integer 15 in the look up table corresponding to the upper 4 bits) also becomes unnecessary. Also in this sense, the size of the look up table can be reduced.

### INDUSTRIAL APPLICABILITY

The softmax function approximation calculation device, the approximation calculation method, and the approximation calculation program according to the present disclosure are useful as techniques capable of suppressing the size of a look up table used for approximation calculation of an exponential function.

### REFERENCE SIGNS LIST

1 Image recognition system
100 Image recognition device
102 Imaging device
200 Softmax function approximation calculation device
300 DCNN (Deep-learning Convolutional Neural Network)
318 Softmax layer
400 FPGA (Field Programmable Gate Array)
401 Register group
402 Quantization circuit
403 Comparison circuit (max)
404 Subtraction circuit (sub)
405 Data division circuit
406 Look up table reference circuit
407 Look up table
408 Multiplication circuit
409 Summing circuit (sum)
410 Divider circuit (div)
420 Main memory
430 Bus interface
table1, table2, table3 Look up table

1. A softmax function approximation calculation device that approximates and calculates, using a plurality of integers or fixed-point numbers as input data, a softmax function value for each piece of the input data, the softmax function approximation calculation device comprising:
a subtractor that calculates a difference value between a common numerical value in a plurality of pieces of the input data and the input data;
a divided data generator that generates divided data by slicing the difference value into a predetermined bit width for each piece of the input data;
a storage that stores a plurality of look up tables that are provided corresponding to bit positions of the divided data in the input data that is a source of the divided data and store an approximate value of an exponential function value corresponding to the divided data as an integer or a fixed-point number;
an acquisitor that refers to the look up table corresponding to the divided data according to the divided data and acquire the approximate value corresponding to the divided data;
a multiplier that calculates a multiplication value of the approximate value corresponding to each piece of the divided data between pieces of the divided data generated by slicing one piece of the input data; and
an approximation calculator that calculates a total value of the multiplication values corresponding to each of the plurality of pieces of the input data and divides the multiplication value by the total value for each piece of the input data to approximate and calculate a softmax function value of the input data.

2. The softmax function approximation calculation device according to claim 1, comprising:
a main memory that stores the plurality of pieces of the input data; and
a register and a bus for acquiring the plurality of pieces of the input data from the main memory, wherein
the subtractor is a subtraction circuit that calculates the difference value by acquiring the plurality of pieces of input data from the main memory via the register,
the divided data generator is a data division circuit,
the storage includes a register file or a memory that stores the look up table,
the acquisitor is a look up table reference circuit, and
the unit multiplier is a multiplication circuit.

3. The softmax function approximation calculation device according to claim 1, wherein
the subtractor sets the common numerical value such that the difference value is 0 or less for all of the plurality of pieces of the input data.

4. The softmax function approximation calculation device according to claim 3, wherein
the common numerical value is maximum input data among the plurality of pieces of the input data, and
the difference value is a value obtained by subtracting the maximum input data from the input data.

5. The softmax function approximation calculation device according to claim 3, wherein
the subtractor obtains a subtraction value in which the input data is subtracted from the common numerical value and to subsequently obtain, as the difference value, a value obtained by removing a sign of the subtraction value.

6. The softmax function approximation calculation device according to claim 1, wherein
the acquisitor acquires an approximate value of an exponential function value stored in a field corresponding to a value of the divided data in the look up table corresponding to the divided data.

7. The softmax function approximation calculation device according to claim 1, wherein
the look up table stores all approximate values corresponding to possible values of divided data corresponding to the look up table.

8. The softmax function approximation calculation device according to claim 1, wherein
the look up table stores, as the approximate value of the exponential function value corresponding to the divided data, an approximate value of an exponential function value having the divided data as an exponential value.

9. The softmax function approximation calculation device according to claim 8, wherein
the exponential function value corresponding to the divided data is an exponential function value having Napier's constant e as a base.

10. The softmax function approximation calculation device according to claim 1, wherein
the storage unit comprises an approximation calculator that calculates, for each of the look up tables, all approximate values corresponding to possible values of divided data corresponding to the look up tables, and stores the calculated approximate values in the look up tables.

11. The softmax function approximation calculation device according to claim 1, wherein
the acquisitor uses the divided data per se as address information of the look up table corresponding to the divided data, and acquires an approximate value of an exponential function value stored in a storage area indicated by the address information from the look up table.

12. The softmax function approximation calculation device according to claim 1, wherein
the multiplier comprises a shift operator that performs a shift operation so that the multiplication value becomes a fixed-point number having a predetermined number of bits and a fixed point at a predetermined position.

13. The softmax function approximation calculation device according to claim 12, wherein
the shift operator performs rounding processing together with the shift operation.

14. The softmax function approximation calculation device according to claim 13, wherein
the rounding processing is performed such that a sign of an error generated after the rounding processing is not only one of positive and negative.

15. The softmax function approximation calculation device according to claim 13, wherein
the rounding processing is rounding off.

16. The softmax function approximation calculation device according to claim 1, comprising
a quantizer that quantizes a plurality of floating-point numbers into integers or fixed-point numbers to generate the plurality of pieces of the input data.

17. The softmax function approximation calculation device according to claim 16, wherein
the plurality of floating-point numbers are data to be input to a softmax layer constituting a neural network.

18. A softmax function approximation calculation method of calculating, using a plurality of integers or fixed-point numbers as input data, a softmax function value for each piece of the input data, the softmax function approximation calculation method comprising:
calculating a difference value between a common numerical value in a plurality of pieces of the input data and the input data;
generating divided data by slicing the difference value into a predetermined bit width for each piece of the input data;
storing a plurality of look up tables that are provided corresponding to bit positions of the divided data in the input data that is a source of the divided data and storing an approximate value of an exponential function value corresponding to the divided data as an integer or a fixed-point number;
referring to the look up table corresponding to the divided data according to the divided data and acquiring the approximate value corresponding to the divided data;
calculating a multiplication value of the approximate value corresponding to each piece of the divided data between pieces of the divided data generated by slicing one piece of the input data; and
calculating a total value of the multiplication values corresponding to each of the plurality of pieces of the input data and dividing the multiplication value by the total value for each piece of the input data to calculate a softmax function value of the input data.

19. A non-transitory recording medium storing a computer readable softmax function approximation calculation program that causes a computer to calculate, using a plurality of integers or fixed-point numbers as input data, a softmax function value for each piece of the input data, the softmax function approximation calculation program causing the computer to perform:
calculating a difference value between a common numerical value in a plurality of pieces of the input data and the input data;
generating divided data by slicing the difference value into a predetermined bit width for each piece of the input data;
storing a plurality of look up tables that are provided corresponding to bit positions of the divided data in the input data that is a source of generation of the divided data and storing an approximate value of an exponential function value corresponding to the divided data as an integer or a fixed-point number;
referring to the look up table corresponding to the divided data according to the divided data and acquiring the approximate value corresponding to the divided data;
calculating a multiplication value of the approximate value corresponding to each piece of the divided data between pieces of the divided data generated by slicing one piece of the input data; and
calculating a total value of the multiplication value corresponding to each of the plurality of pieces of the input data and dividing the multiplication value by the total value for each piece of the input data to calculate a softmax function value of the input data.

20. The softmax function approximation calculation device according to claim 2, wherein
the subtractor sets the common numerical value such that the difference value is 0 or less for all of the plurality of pieces of the input data.
